(19) United States
(12) Patent Application Publication
(10) Pub. No.: US 2005/0169825 A1
(43) Pub. Date: Aug. 4, 2005

(54) Method of collecting carbon dioxide contained in fumes

(76) Inventors: Renaud Cadours, Francheville (FR); Pierre-Louis Carrette, Lyon (FR); Pascal Mougin, Rueil Malmaison (FR); Paul Broutin, Chaponost (FR); Pierre Boucot, Ternay (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/014,788

(22) Filed: Dec. 20, 2004

(30) Foreign Application Priority Data
Dec. 23, 2003 (FR) 03/15.213

(51) Int. Cl. B01D 53/62

(52) U.S. Cl. 423/220

(57) ABSTRACT

The fumes flowing in through line 1 are contacted in column C1 with a solvent, at low vapour pressure, absorbing the carbon dioxide. The solvent laden with carbon dioxide is regenerated by distillation in column C2. In order to improve the regeneration operation, a gas is injected through line 11 into column C2 so that this gas carries along the carbon dioxide contained in the solvent. The carbon dioxide-rich gaseous effluent obtained at the top of column C2 can be liquefied by compression and cooling, then stored in surge tank R, which allows its transportation and possibly underground sequestration.

### FIELD OF THE INVENTION

The present invention relates to a method of collecting carbon dioxide contained in combustion fumes.

### BACKGROUND OF THE INVENTION

Atmospheric pollution is a phenomenon which gains in importance, as regards the emission sources as well as the amounts of compounds emitted and the impact of the pollution on man and on the environment. Carbon dioxide (CO₂) is one of the greenhouse effect gases widely produced by man's various activities, notably by the combustion of hydrocarbons.

In order to reduce the amounts of carbon dioxide discharged to the atmosphere, it is possible to collect the carbon dioxide contained in industrial fumes, which are fixed and important sources.

There are methods of collecting carbon dioxide by fumes washing using a solvent. The physico-chemical characteristics of the solvents used are closely linked with the nature of the fumes: selective elimination of an impurity, thermal and chemical stability of the solvent towards the various compounds present in the fume.

In general, the composition of a fume corresponds, by volume, to about 75% nitrogen, 15% carbon dioxide, 5% oxygen and 5% water. Various impurities such as sulfur oxides (SOx), nitrogen oxides (NOx), argon (Ar) and other particles are also present, in lower proportions, generally representing less than 2% by volume. The temperature of these fumes before treatment ranges between 50° C. and 180° C., the pressure is generally below 2 MPa.

Treatment of the fumes requires constraints specific to the solvent: selectivity towards carbon dioxide in relation to oxygen and nitrogen notably, thermal stability, chemical stability notably towards the fume impurities, i.e. oxygen, SOx and NOx, and a low vapour pressure, in order to limit solvent losses at the top of the decarbonation column.

The most commonly used solvents today are aqueous alkanolamine solutions, primary, secondary or tertiary. In fact, the absorbed CO₂ reacts with the alkanolamine present in solution, according to an exothermic reaction. The velocity of the reaction, its exothermicity, the stability of the reaction products and the corrosive character of the solution decrease as the substitution level of the nitrogen atom of the molecule increases. Tertiary alkanolamines are preferably used to minimize corrosion and solvent loss problems due to chemical degradation. On the other hand, their drawback lies in their limited capacity and in a slow chemical association with CO₂ as regards material transfer phenomena, which implies that particular attention has to be paid to the dimensioning of the absorbers. Secondary alkanolamines and mainly primary alkanolamines are therefore preferably used, despite higher solvent corrosion and chemical degradation risks. Monoethanolamine (MEA) can be mentioned by way of example, whose high absorption capacity allows to exceed 90% CO₂ elimination in the low partial pressures range characteristic of fumes. The main drawback of these alkanolamine-based solvents lies in their chemical instability, partly towards CO₂, but also towards SOx and oxygen. In fact, alkanolamines react irreversibly with oxygen. The products of these reactions are carboxylic acids that may initiate corrosion problems. Besides, regeneration of these alkanolamine-based aqueous solvents requires a substantial energy supply, partly corresponding to the reaction heat between the alkanolamine and the carbon dioxide, approximately 30% of the total regeneration energy, and to the production of an amount of vapour allowing to carry out regeneration of the solvent by gas entrainment, commonly referred to as stripping (70%).

An alternative to aqueous alkanolamine solutions are warm carbonate solutions. The principle is based on the absorption of the CO₂ in the aqueous solution, followed by the chemical reaction with the carbonates. It is well-known that the addition of additives allows the solvent efficiency to be optimized. These additives are in most cases primary or secondary amines, such as diethanolamine (DEA). The use of such additives in the case of fumes treatment has to be questioned because of their instability, notably towards oxygen.

Other solvent decarbonation methods are based on physical CO₂ absorption. In the aqueous alkanolamine or carbonate solutions, the solvent selectivity, notably towards nitrogen, is provided by the chemical reaction. In the case of solvents performing a physical absorption, such as refrigerated methanol or polyethylene glycols for example, a quite significant co-absorption of the nitrogen in parallel to the absorption of the CO₂ is generally observed. In fact, the large proportion of nitrogen in the fume to be treated, compared to the amount of CO₂, implies a driving force difference between the two gases, that has to be compensated by the solvent selectivity. This nitrogen co-absorption is in most cases disadvantageous.

The use of ionic liquids as proposed in document U.S. Pat. No. 6,579,343 would allow to provide a selectivity between CO₂ and nitrogen. The significance of these solvents is also their low vapour pressure and their thermal stability. It also has to be noted that these compounds are generally hydrophilic and that, in the case of the aforementioned fumes, assuming that the ionic liquids withstand the oxygen, the SOx and the NOx, a partial dehydration of the fumes would be closely linked wit the decarbonation. The amount of water removed during treatment of the fume is linked with the water content of the solvent from the regeneration stage.

Whatever the nature of the solvent, physical and/or chemical, an essential aspect of these solvent treating operations is the regeneration of the separation agent. In the case of solvents performing a physical absorption, regeneration by expansion is often proposed. However, with low-pressure fumes, this regeneration mode does not allow to obtain a sufficient solvent purity to reach the desired efficiency in the decarbonation stage. A conventional regeneration by distillation is therefore carried out, whatever the nature of the solvent. The efficiency of this operation lies in the creation of a vapour stream by evaporation of an amount of solvent in the boiler of the distillation column. The drawback however is the energy required for this vaporization, which can reach 70% of the energy consumption of the regeneration stage. Within the context of aqueous alkanolamine or carbonate solutions, or in the case of physical solvents such as methanol or mixtures of polyethylene glycol and water, the vapour stripping effect is readily obtained by evaporation of an amount of solvent, however at the cost of a high energy consumption. In the case of a solvent of very low vapour pressure, such as an ionic liquid, this stripping effect is generally difficult to obtain. Ionic liquids such as those described in document U.S. Pat. No. 6,579,343, by their hydrophilic nature, have a water content that depends on the dehydration performed simultaneously with the gas decarbonation. During the regeneration by distillation stage, the amounts of water released by the ionic solvent are not sufficient to provide this stripping effect. The result is only partial regeneration of the solvent as regards CO₂ and the decarbonation efficiency cannot be obtained.

### SUMMARY OF THE INVENTION

The present invention thus proposes a method of collecting the carbon dioxide present in combustion fumes prior to possible sequestration of the carbon dioxide collected.

In general terms, the invention relates to a method of collecting the carbon dioxide present in combustion fumes, wherein the following stages are carried out:
a) contacting the fumes with a carbon dioxide-absorbing solvent so as to obtain carbon dioxide-depleted fumes and a carbon dioxide-laden solvent, and
b) regenerating the carbon dioxide-laden solvent by distillation in a column, a gas being injected into the column, so as to obtain a regenerated solvent and a gaseous effluent comprising carbon dioxide, the volume flow rate of said gas being less than 10% of the volume flow rate of the fumes to be treated in stage a).

Furthermore, the following stages can be carried out:
c) liquefying the gaseous effluent obtained in stage b), and
d) storing the liquid obtained in stage c) in a tank.

According to the invention, in stage c), the gaseous effluent can be compressed and cooled.

According to the invention, before stage b), the carbon dioxide-laden solvent can be expanded so as to release part of the carbon dioxide. Part of the expanded solvent can be contacted with the fumes in stage a). In stage c), the gaseous effluent obtained in stage b) and the part of the carbon dioxide released through expansion of the solvent can be liquefied.

Alternately, according to the invention, before stage b), the carbon dioxide-laden solvent can be compressed.

According to the invention, the regenerated solvent can be recycled to stage a) as carbon dioxide-absorbing solvent.

The solvent can have a vapour pressure lower than 0.1 MPa abs. at 100° C. For example, the solvent comprises at least one of the following compounds: a glycol, a glycol ether, an alcohol, sulfolane, N-methylpyrrolidone, propylene carbonate, an ionic liquid, an amine, an alkanolamine, an amino-acid, an amide, a urea, a phosphate, a carbonate and an alkali metal borate.

The gas can comprise less than 15% by volume of carbon dioxide. For example, the gas is selected from the following list of gases: part of the fumes discharged before stage a), part of the carbon dioxide-depleted fumes obtained in stage a), natural gas, air.

According to the invention, stage a) can be carried out at a pressure ranging between 0.1 and 10 MPa abs., and at a temperature ranging between 0° C. and 80° C., and stage b) can be carried out at a pressure ranging between 0.01 and 0.2 MPa abs.

### BRIEF DESCRIPTION OF THE FIGURE

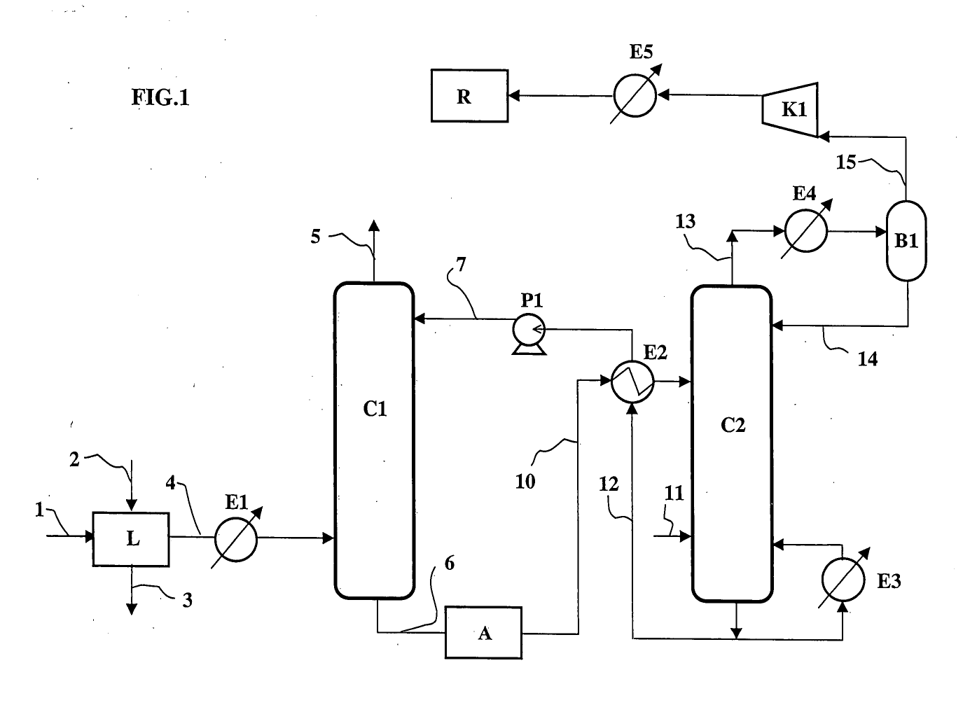

Other features and advantages of the invention will be clear from reading the description hereafter, with reference to FIG. 1 which diagrammatically shows the method according to the invention.

### DETAILED DESCRIPTION

With reference to FIG. 1, fumes to be treated flow in through line 1. For example, the fumes can be produced by the combustion of hydrocarbons in a boiler or by a combustion gas turbine. These fumes can comprise 50% to 80% nitrogen, 5% to 20% carbon dioxide (CO₂), 2% to 10% oxygen (O₂), and various impurities such as SOx, NOx, dusts or other particles. The fumes can be available at a pressure ranging between 0.1 MPa abs. and 10 MPa abs., preferably ranging between 0.1 MPa abs. and 2 MPa abs., and at a temperature ranging between 40° C. and 500° C., preferably between 40° C. and 180° C.

The fumes circulating in line 1 can be subjected to a pre-treatment in zone L so as to remove the dusts and part of the gaseous impurities such as SOx and NOx. Pre-treatment can comprise a stage of washing the fumes with water: the fumes are contacted with water flowing in through line 2, for example in a quenching tower. The fumes can circulate countercurrent to the water. Washing with water allows, on the one hand, to remove the dusts and, on the other hand, to cool the fumes, for example to a temperature ranging between 0° C. and 80° C. The impurity-laden water heated by the fumes is discharged through line 3. Cooling allows to favour absorption of the carbon dioxide by the solvent in column C1. Pre-treatment can also comprise other stages allowing more specifically to collect the SOx and NOx upstream from the water washing stage.

The fumes discharged from zone L through line 4 can be subjected to a complementary cooling stage in heat exchanger E1. The fumes are then fed into contacting column C1.

In column C1, the fumes are contacted with a decarbonation solvent flowing in through line 7.

The decarbonation solvent is selected for its capacity to absorb carbon dioxide. This solvent can be an absorption solution consisting of at least one or more organic compounds and/or of one or more compounds having the capacity to react reversibly with CO₂. The compound(s) reacting with CO₂ can also be functions grafted on the organic compound(s). The solvent used can contain water. The organic compounds can be, for example, glycols, glycol ethers, alcohols, sulfolane, N-methylpyrrolidone, propylene carbonate or ionic liquids. The reactive compounds can be for example, in a non limitative way, amines (primary, secondary, tertiary, cyclic or not, aromatic or not), alkanolamines, amino-acids, amides, ureas, phosphates, carbonates or alkali metal borates. The solvent can further contain anticorrosion and/or antifoam additives. The vapour pressure of the solvent at 100° C. can be less than 0.1 MPa abs., preferably less than 0.05 MPa abs. and more preferably less than 0.02 MPa abs.

Contacting with the decarbonation solvent can be carried out in a conventional way in one or more cocurrent or countercurrent contacting columns. The columns can be packed with perforated bubble-cap or valve trays. The columns can also be of random or stacked packing type. It is also possible to use membrane contactors in order to optimize contact between the gas and the liquid.

In column C1, the solvent collects and absorbs the carbon dioxide contained in the fumes. The solvent absorbs at least 50%, preferably at least 80% or 90% of the CO₂ contained in the fumes flowing in through line 1. The solvent can also co-absorb other compounds contained in the fumes, such as nitrogen (N₂), oxygen (O₂), SOx and NOx. The co-absorbed amounts depend on the nature of the solvent, but they are generally less than 50%, preferably less than 5% of the compounds collected by the solvent. The carbon dioxide-depleted fumes are discharged from column C1 through line 5. The carbon dioxide-laden solvent is discharged through line 6.

The carbon dioxide-laden solvent is fed into device A allowing the pressure of the solvent to be changed. The pressure of the solvent can be adjusted to a value ranging between 0.01 and 1 MPa abs., preferably between 0.01 and 0.2 MPa abs. The solvent obtained at the outlet of device A is discharged through line 10.

The fumes produced in a boiler are generally available at a pressure close to atmospheric pressure. In this case, device A can be a pump for raising the pressure of the solvent.

The fumes produced in a gas turbine are generally available at a pressure above 0.5 MPa. In this case, device A can be a valve and/or an expander. Upon expansion, part of the carbon dioxide absorbed by the solvent and possibly part of the impurities are released in form of a gaseous effluent. This effluent can be mixed with other carbon dioxide-rich effluents for liquefaction and storage. The solvent obtained after expansion is partly regenerated, i.e. depleted in carbon dioxide. Part of the partly regenerated solvent can be fed into column C1.

Alternately, device A may not exist and the solvent circulating in line 6 can be directly transferred into line 10.

The solvent circulating in line 10 is heated in heat exchanger E2, then fed into column C2 to be regenerated, i.e. to separate the solvent from the carbon dioxide. In column C2, distillation of the solvent is carried out to obtain, at the bottom of column C2, a carbon dioxide-depleted regenerated liquid solvent and, at the top of column C2, a gaseous effluent containing carbon dioxide. Reboiler E3 arranged at the bottom of column C2 supplies the heat required for distillation. Distillation can be performed at a pressure close to atmospheric pressure, for example between 0.01 and 0.2 MPa abs. The distillation temperature is selected according to the solvent used. In general, the temperature at the bottom of column C2 can range between 100° C. and 200° C., depending on the solvent and on the pressure in column C2.

Regeneration can be conventionally performed in one or more columns that can be packed with perforated bubble-cap or valve trays. These columns can also be of random or stacked packing type.

In order to improve regeneration, a gas providing an effect commonly referred to as stripping effect, i.e. the gas carries in the vapor phase the carbon dioxide contained in the solvent to be regenerated, is fed into the bottom of column C2 through line 11. The volume flow rate of the gas can be less than 10%, preferably less than 5% and advantageously less than 3% of the flow rate of the fumes to be treated, flowing in through line 1. In general, the gas flow rate is greater than 0.5% of the flow rate of fumes to be treated.

The combination of the solvent temperature rise in column C2 and of the stripping effect of the gas injected through line 11 into column C2 allows to carry out regeneration of the solvent. Injection of the gas at the bottom of column C2 contributes to the proper running of column C2 by providing a sufficient gas flow rate on the various trays of column C2. Thus, the stripping effect applies particularly well to the regeneration of solvents at low vapour pressure, below 0.1 MPa abs. at 100° C.

The gas fed into column C2 through line 11 can be part of the fumes flowing in through line 1, part of the fumes circulating in line 4 and/or part of the treated fumes circulating in line 5. This gas can also be an inert gas with carbon dioxide and containing, by volume, less than 15% carbon dioxide, for example natural gas or air. The carbon dioxide content of the gas fed into C2 through line 11 involves a thermodynamic limitation to the regeneration of the solvent. This limit can be shifted by increasing the temperature at which regeneration is carried out.

The regenerated solvent obtained at the bottom of column C2 is discharged through line 12, cooled in heat exchanger E2, pumped by pump P1, then fed into column C1 through line 7.

The gaseous effluent obtained at the top of column C2 is discharged through line 13, partly liquefied by heat exchanger E4 at a temperature ranging for example between 30° C. and 60° C., then fed into drum B1. The liquid obtained at the bottom of drum B1 is fed to the top of column C2 through line 14 as reflux. The gas fraction discharged at the top of drum B1 through line 15 comprises the carbon dioxide removed from the fumes to be treated flowing in through line 1. The carbon dioxide content of this gas fraction depends on the flow rate of the stripping gas fed into column C2 through line 11. Using a low gas flow rate, preferably less than 10% of the flow rate of the fumes to be treated, allows to obtain at the top of C2 a very CO₂-rich gaseous effluent. The gas fraction discharged through line 15 consists of at least 50%, preferably more than 85% and ideally more than 95% carbon dioxide. Thus, this gas fraction can be directly liquefied and stored without any complementary treatment.

Besides, using a low stripping gas flow rate does not allow to perform intensive regeneration of the solvent in column C2. However, this is not a drawback for the method according to the invention because the absorption power of the solvent in column C1 does not need to be optimal. In fact, decarbonation of the fumes for CO₂ sequestration does not require severe specifications as regards the CO₂ content of the treated fumes.

In a carbon dioxide liquefaction perspective, with a view to its transportation and sequestration, the gas fraction circulating in line 15, possibly mixed with the gaseous effluent released upon expansion in device A, can be liquefied by compression performed by compressor K1 and by cooling in heat exchanger E5. Liquefaction can also be carried out by a succession of compression, possibly pumping, and cooling stages. Cooling allows the temperature to be maintained between 10° C. and 60° C., preferably between 20° C. and 35° C., in order to provide condensation of the carbon dioxide-rich effluent. This liquid effluent can be temporarily stored in tank R. Then, the CO₂-rich effluent can be sequestered in an underground reservoir. The liquid effluent can be subjected to distillation to separate the nitrogen and the carbon dioxide, but it is also possible to sequester all of the nitrogen with the carbon dioxide.

The method according to the invention described in connection with FIG. 1 is illustrated by the following numerical examples.

The fumes to be treated flow in through line 1 at a flow rate of 585 000 Nm³/h and have the volume composition given in the table hereafter:

| CO₂ | N₂ | O₂ | Ar | CO₂ |
|---|---|---|---|---|
| 4.81% | 75.23% | 5.73% | 0.96% | 13.27% |

These fumes were subjected to a prior treatment to reduce the SOx and NOx contents respectively to less than 20 ppmv and 10 ppmv. This pre-treatment allows to remove these impurities that may degrade the alkanolamine used as absorption solvent.

Contacting with water in a wash tower L allows to eliminate the residual dusts and to cool the fumes down to 40° C. before entering absorption column C1.

For each one of the two cases described below, column C2 works at 0.11 MPa abs., the fumes are injected at 40° C. at the bottom of C2 and the solvent is injected at 45° C. at the top of C2. In both cases, we consider a carbon dioxide collection rate of 90%, which allows to recover 137.2 t/h carbon dioxide at the top of regeneration column C2.

Case 1

The solvent used is an aqueous solution containing 30% by weight of MEA (monoethanolamine). In order to collect 90% of the CO₂, a flow rate of 2400 m³/h of an aqueous solution is injected at the inlet of C1. Regeneration of this solution obtained at the bottom of C1 is carried out by distillation, at a pressure of 0.17 MPa abs. at the top of column C2. The temperatures at the bottom and at the top of column C2 are respectively 122° C. and 40° C. to allow regeneration of the solvent.

Considering the thermal exchange in exchanger E2 between the carbon dioxide rich and poor solutions, an amount of heat equal to 120 Gcal/h is supplied through reboiler E3 of column C2.

Case 2

The solvent used is a tetraethylene glycol dimethyl ether solution containing 30% by weight of MEA (monoethanolamine). To collect 90% of the CO₂, a 2600 m³/h flow rate of solvent is injected at the inlet of C1. Regeneration of this solution obtained at the bottom of C1 is carried out by distillation, at a pressure of 0.17 MPa abs. at the top of column C2. To favour regeneration of the solvent, 1% of the flow of decarbonated fumes obtained at the top of column C1 is fed into the bottom of regeneration column C2, this stream of fumes allowing to strip the carbon dioxide contained in the solvent. The temperatures at the bottom and at the top of column C2 are then respectively 125° C. and 40° C. to allow regeneration of the solvent. Considering the thermal exchanges, on the one hand, between the carbon dioxide-rich solution and the stripping fumes in C2 and, on the other hand, between the carbon dioxide rich and poor solutions in heat exchanger E2, it is necessary to supply, through reboiler E3 of column C2, an amount of heat equal to 88 Gcal/h.

In case 2, stripping with a stream of decarbonated fumes allows regeneration of the solvent even if the solution is not aqueous but a mixture of alkanolamine in a co-solvent at low vapour pressure. The stripping effect previously obtained in case 1 with vaporization of the water is obtained in case 2 by injection of an inert gas, here the stream of decarbonated fumes, into regeneration column C2. A 27% reduction in the reboiling heat required for regeneration of the solvent to obtain the same production of carbon dioxide at the top of the regenerator can also be noted. This reboiling heat reduction is explained by the absence, in case 2, of vaporization of the solvent.

1. A method of collecting the carbon dioxide present in combustion fumes, wherein the following stages are carried out:
a) contacting the fumes with a carbon dioxide-absorbing solvent so as to obtain carbon dioxide-depleted fumes and a carbon dioxide-laden solvent, and
b) regenerating the carbon dioxide-laden solvent by distillation in a column (C2), a gas being injected into the column, so as to obtain a regenerated solvent and a gaseous effluent comprising carbon dioxide, the volume flow rate of said gas being less than 10% of the volume flow rate of the fumes to be treated in stage a).

2. A method as claimed in claim 1, wherein the following stages are also carried out:
c) liquefying the gaseous effluent obtained in stage b), and
d) storing the liquid obtained in stage c) in a tank.

3. A method as claimed in claim 2, wherein the gaseous effluent is compressed and cooled in stage c).

4. A method as claimed in claim 1 wherein, prior to stage b), the carbon dioxide-laden solvent is expanded so as to release part of the carbon dioxide.

5. A method as claimed in claim 4, wherein part of the expanded solvent is contacted with the fumes in stage a).

6. A method as claimed in claim 4 wherein, in stage c), the gaseous effluent obtained in stage b) and the part of the carbon dioxide released by expansion of the solvent are liquefied.

7. A method as claimed in claim 1 wherein, prior to stage b), the carbon dioxide-laden solvent is compressed.

8. A method as claimed in claim 1, wherein the regenerated solvent is recycled to stage a) as carbon dioxide-absorbing solvent.

9. A method as claimed in claim 1, wherein the solvent has a vapour pressure below 0.1 MPa abs. at 100° C.

10. A method as claimed in claim 9, wherein the solvent comprises at least one of the following compounds: a glycol, a glycol ether, an alcohol, sulfolane, N-methyl-pyrrolidone, propylene carbonate, an ionic liquid, an amine, an alkanolamine, an amino-acid, an amide, a urea, a phosphate, a carbonate and an alkali metal borate.

11. A method as claimed in claim 1, wherein said gas comprises less than 15% by volume of carbon dioxide.

12. A method as claimed in claim 11, wherein the gas is selected from the following list of gases: part of the fumes discharged before stage a), part of the carbon dioxide-depleted fumes obtained in stage a), natural gas, air.

13. A method as claimed in claim 1, wherein:
stage a) is carried out at a pressure ranging between 0.1 and 10 MPa abs., and at a temperature ranging between 0° C. and 80° C.,
stage b) is carried out at a pressure ranging between 0.01 and 0.2 MPa abs.
